(19) United States
(12) Patent Application Publication
(10) Pub. No.: US 2025/0042475 A1
(43) Pub. Date: Feb. 6, 2025

(54) Reinforcement Member Particularly for an Electric Vehicle

(71) Applicant: Zephyros, Inc., Romeo, MI (US)

(72) Inventors: Manuel Kesseler, Molsheim Cedex (FR); Peter Cate, Gloucestershire (GB); Nuria Ignes I Mullol, Forchheim (DE); Gerald Bugli, Molsheim Cedex (FR)

(21) Appl. No.: 18/713,306

(22) PCT Filed: Nov. 22, 2022
(86) PCT No.: PCT/EP2022/082830

§ 371 Date: May 24, 2024

(30) Foreign Application Priority Data
Nov. 25, 2021 (EP) 21210369.1
Aug. 15, 2022 (EP) 22190371.9

(51) Int. Cl. B62D 21/15; B62D 27/02

(52) U.S. Cl. CPC B62D 21/15; B62D 27/023

(57) ABSTRACT

The present invention relates to a reinforcement member (13) for a vehicle, particularly an electric vehicle, which comprises at least one profile (1) each with an axial extension (11) and a perimeter (12) and with at least one, preferably a multitude, of structure-improvement-part(s) (2-4) provided at, at least, a section of the perimeter (12) of the profile(s) (1). The present invention also relates to an automotive part (8) comprising the reinforcement member (13) and an electric vehicle (10).

The present invention relates to a reinforcement member for a vehicle, particularly an electric vehicle, which comprises at least one profile each with an axial extension and a perimeter and with at least one, preferably a multitude, of structure-improvement-part(s) provided at, at least, a section of the perimeter of the profile(s). The present invention also relates to an automotive part comprising the reinforcement member and an electric vehicle.

Reinforcement member for automotive vehicles are well known in the state in the art. However, for electric vehicles, there are specific needs, for example to protect the batteries or a significantly reduced weight, which require a new design for those parts.

It was therefore the problem of the present invention to provide such reinforcement members.

The problem is solved with a reinforcement member for a vehicle, particularly an electric vehicle, which comprises at least one profile, each with an axial extension and a perimeter and with at least one, preferably a multitude, of structure-improvement-part(s) provided at, at least, a section of the perimeter of the profile(s) and/or inside the profile(s).

The disclosure regarding this embodiment of the present invention also applies to the other embodiments and vice versa. Subject matters disclosed in the context of this embodiment of the present invention can also be combined with other embodiments and vice versa.

The present invention relates to a reinforcement member for a vehicle, particularly an electric vehicle. A vehicle can be any vehicle utilized for transportation of goods and/or humans, particularly, a car, a truck, a bus etc. An electric driven vehicle according to the present invention may comprise a combustion engine, but necessarily has an e-motor to drive the vehicle. Specifically, an electric driven vehicle comprises a battery and/or a fuel-cell and or is a hybrid-solution with an e-and a combustion-engine.

According to the present invention, the reinforcement member comprises at least one profile. This profile can be a straight or a curved profile. The profile is preferably a continuous profile whose cross-section and/or perimeter, at least essentially, does not change along its axial extension. The profile is preferably an extruded-and/or pultruded-and/or mechanically formed profile, for example rolled or flexible roll formed. The profile may be a hollow structure, preferably with at least one rib. The profile may comprise on or more undercuts, particularly to improve the connection with the structure-improvement-part. Preferably, the profile has a commonly used cross-section. The extension of the profile in axial direction is preferably much longer than the dimensions of its cross-section. The profile preferably has a length of >20 cm, more preferably >30 cm, even more preferably >50 cm and even more preferably >70 cm. The reinforcement member may comprise more than one profile, which are more preferably joint by one or more structure-improvement-part(s). Preferably, the profile comprises a longitudinal axis. Preferably, the cross-section of the profile has at least one, preferably two, symmetry-plane(s).

The profile can be made from a metal, preferably aluminum or a sheet metal or an organic material, preferably a composite body, comprising two or more materials, preferably layers of material. The materials can be metal, an organic material or a combination thereof.

At its perimeter, preferably the perimeter of the cross-section, at least at a section of the perimeter, at least one, preferably a multitude of, individual structure-improvement-part(s) are provided. These structure-improvement-part(s) locally improve the mechanical properties of the part of the vehicle that shall be reinforced, for example its energy absorbing-, load-path-management-, a sealing-, a vibration-dampening-, anti-buckling, twist-resistance-improvement and/or a stiffening-properties. Preferably, each structure-improvement-part is tailor-made for the specific local reinforcement need.

Anti-buckling according to the invention preferably includes an absorption and/or alteration of a buckling load in space and/or time.

Preferably, the reinforcement member comprises a multitude of structure-improvement-part(s) which are distributed along the axial length of the profile, preferably not equidistantly, but according to the localized mechanical need. Preferably, the distance between two adjacent reinforcement members varies. Preferably, two adjacent reinforcement members differ from each other in shape and/or chemical composition.

In a preferred embodiment, the perimeter of the profile has two opposing surfaces. According to a preferred embodiment of the present invention, more than one reinforcement members, preferably two different reinforcement members, are provided at these surfaces.

The profile comprises two end-sections and preferably at least one end section is provided with a structure-improvement-part. Preferably, this reinforcement member extends into and/or out of the surface of the profile. Preferably the reinforcement member is used as connector to connect two otherwise separate automotive parts and/or the reinforcement member is utilized to direct and/or distribute a load induced into the vehicle.

According to a preferred embodiment, the structure-improvement-part connects two or more profiles and/or automotive parts. The connector preferably increases the axial length of the profile.

Preferably, the structure-improvement-part, which is provided at the profile comprises a carrier and/or an adhesive-and/or expandable-material. The carrier, which is preferably different from the profile, can be made from a metal and/or an organic material. The carrier can extend around the entire perimeter of the cross-section of the profile, but preferably covers only part of it. The adhesive-and/or expandable-material can be provided on the carrier and/or on the perimeter of the profile. The adhesive-and/or expandable-material is preferably a structural material. The expandable material preferably expands under the influence of heat; i.e. at elevated temperatures. However, the expansion can also take place under the influence of a chemical substance.

The carrier and/or the adhesive-and/or expandable-material can be applied on the profile by an application technique, preferably molding or injection molding.

The structure-improvement-part preferably increases the energy absorbing-, a load-path-management-, a sealing-, a vibration-dampening-, anti-buckling, twist-resistance-improvement and/or a stiffening-properties of the profile and/or the automotive part in or at which the structure-improvement-part is provided.

The profile may comprise means to connect the structure-improvement-part to the profile. Examples for such means are an undercut and/or an opening.

Another subject matter of the present invention is an automotive part comprising the inventive or preferred reinforcement member disclosed above.

The disclosure regarding this embodiment of the present invention also applies to the other embodiments and vice versa. Subject matters disclosed in the context of this embodiment of the present invention can also be combined with other embodiments and vice versa.

This embodiment of the present invention, which also solves the previously stated problem, relates to an automotive part. This part can be, for example, a rocker, a pillar, a beam and/or any other part of the body in white.

Preferably, automotive part is a hollow structure or has a cavity, wherein the inventive or preferred reinforcement member is provided in the hollow structure or the cavity. Preferably, at least initially, there is, at least locally a gap between the reinforcement member and the automotive part. This gap can be used to apply a coating to the automotive part. The gap can be reduced, preferably closed by expansion of the expandable material.

The inventive automotive part comprising an axial length, which is conventionally much larger than the dimensions of its cross section. Preferably, the axial length of the reinforcement member is at least essentially equal to the axial length of the automotive part.

Preferably, the reinforcement member is inserted into the automotive part or attached to the periphery of the automotive part such that the longitudinal axis of the reinforcement member is in parallel to the longitudinal axis of the automotive part.

According to a preferred embodiment of the present invention, the structure-improvement-part provide at the profile are distributed along the axial length of the automotive part and even more preferably in locations where its structural properties and/or the structural properties of the entire vehicle need to be improved. Preferably, the structure-improvement-parts at the profile are identical or differ in their shape, size and/or chemical composition.

According to another preferred or inventive embodiment of the present invention, the automotive part itself comprises a structure-improvement-part at its circumference. Preferably, the structure-improvement-part is a connector, that connects two automotive parts. The connector may be provided at one of the ends of the automotive part and/or somewhere along its axial extension.

Preferably, the inventive or preferred automotive part is a rocker and/or a rail, particularly a longitudinal rail relative to the lengthwise extension of the vehicle and/or a cross-and/or otherwise angled member and/or a corner reinforcement member.

Preferably, the inventive or preferred automotive part is a battery case, a battery enclosure or the like. The battery case or battery-enclosure are particularly safety relevant parts of an electrical vehicle. Consequently, they need to be particularly stable. The battery case may comprise a beam(s) or the like which is reinforced with the inventive reinforcement member.

The inventive automotive part is particularly suitable for an electric vehicle. Another embodiment of the present invention, which also solves the stated problem is therefore an electric vehicle comprising the inventive or preferred automotive part.

The disclosure regarding this embodiment of the present invention also applies to the other embodiments and vice versa. Subject matters disclosed in the context of this embodiment of the present invention can also be combined with other embodiments and vice versa.

The invention are now explained in detail according to the Figures. These explanations do not limit the scope of protection. They apply to all inventions of the present disclosure likewise.

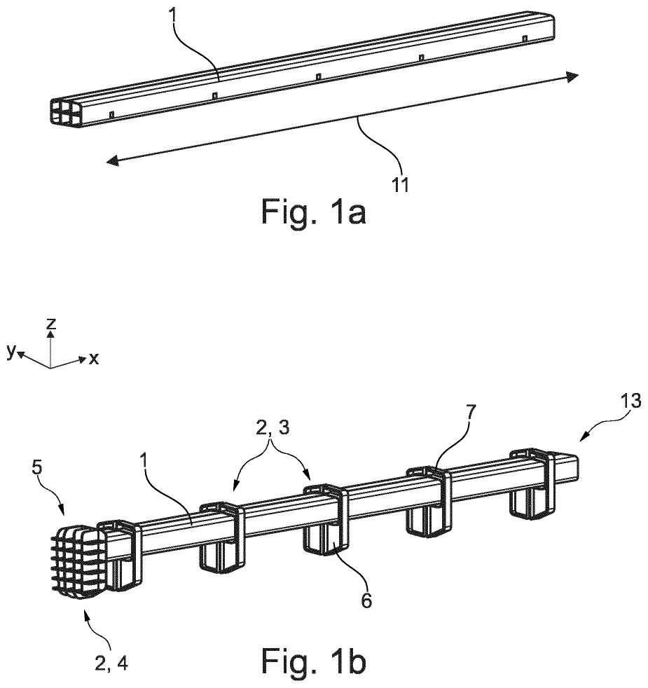

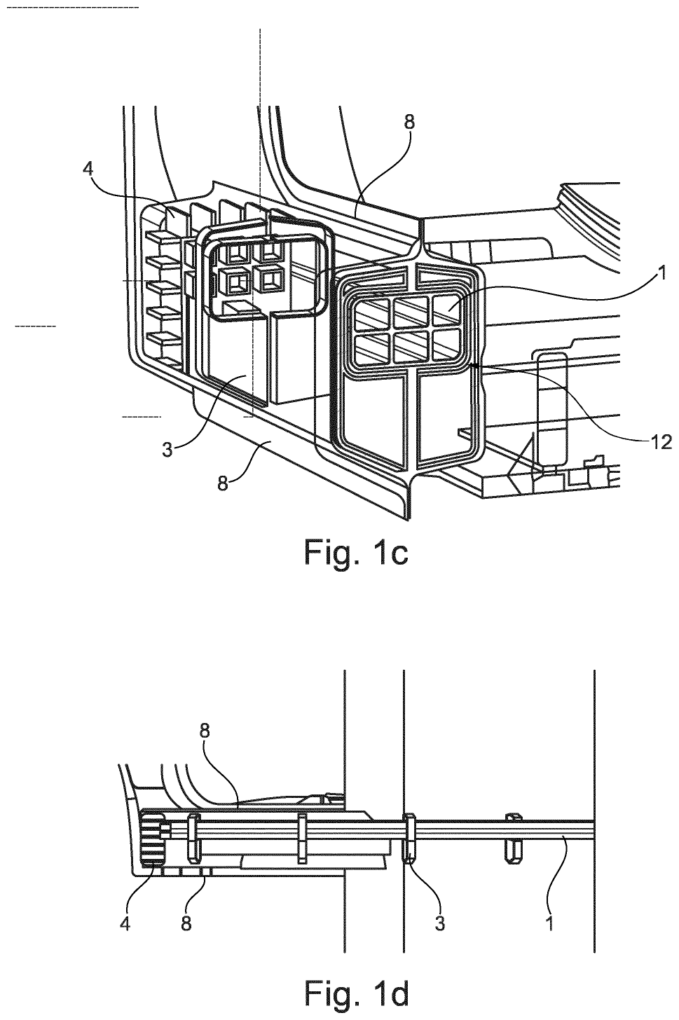

FIGS. 1-4 each depict an embodiment of the inventive reinforcement member.

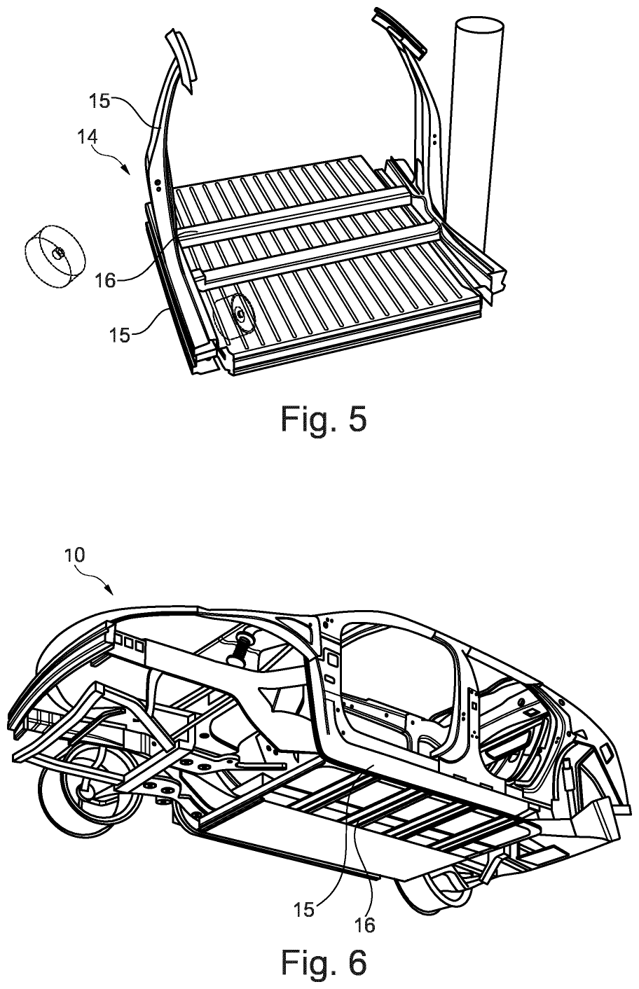

FIG. 5 depicts a battery case or battery enclosure.

FIGS. 6-13 each depict an embodiment of the inventive vehicle.

FIG. 14 depict cross-sections of different embodiments or the inventive reinforcement member.

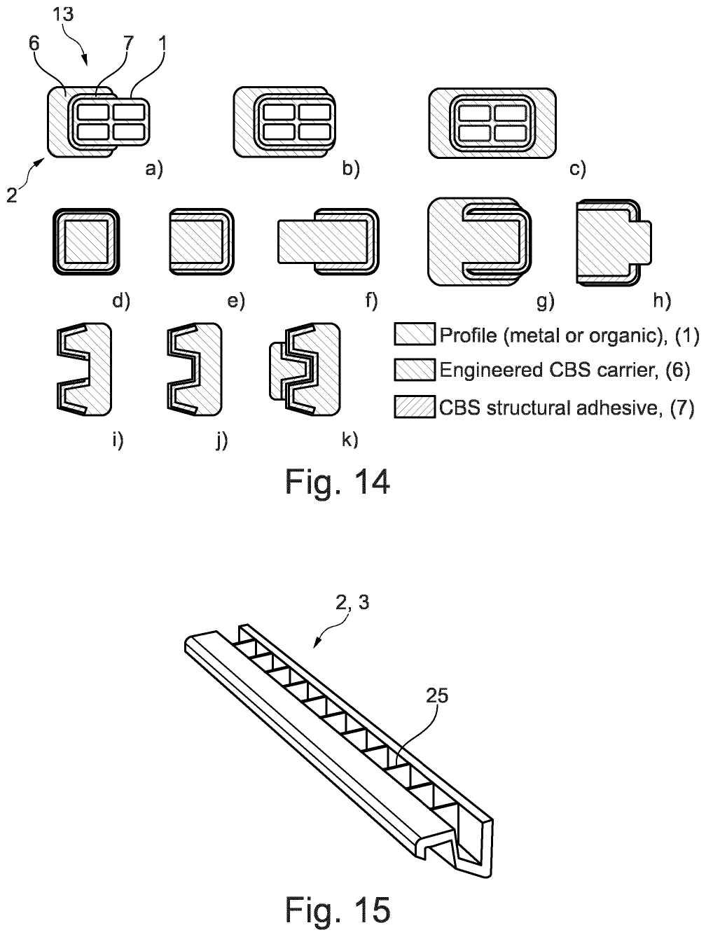

FIG. 15 shows an embodiment of a structure-improvement-part suitable for an application inside the profile.

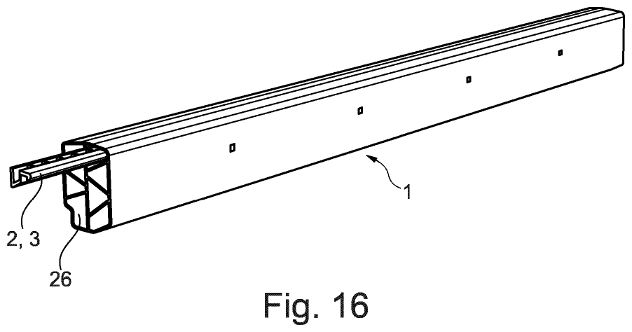

FIG. 16 shows a profile reinforced at its inside.

FIG. 1a of FIG. 1 depicts a first embodiment of the inventive reinforcement member 13. The inventive reinforcement member 13 comprises a profile 1, in the present case with a continuous cross section preferably along its entire axial extension 11. This cross-section has a rectangular periphery 12. The cross-section is preferably hollow and more preferably comprises ribs. The axial extension 11 is much larger than the dimensions of the cross-section. FIG. 1b shows the profile according to FIG. 1a with a multitude of structure-improvement-parts 2-4 provided at the periphery of the profile 1. In the present example, the structure-improvement-parts 2-4 all comprise a carrier 6 and an adhesive and/or expandable material, both preferably made from an organic material. The expandable and/or adhesive material connects the reinforcement member 13 to an automotive part. In the present case, the structure-improvement-parts 2-4 extend around the entire cross-section of the profile. The structure-improvement-parts 2-4 are distributed along the length of the profile in locations, in which improvement of the mechanical properties of the profile and/or an automotive part are needed. In the present case there are four identical structure-improvement-parts 3 and one end-section-structure-improvement-part 4 provided. The end-section-structure-improvement-part 4 can be utilized to connect two reinforcement members 13 and/or two or more automotive parts 8 and/or to direct a load into the reinforcement member and/or the automotive part 8. The structure-improvement-part may comprise stiffening ribs. FIGS. 1 c and d show the inventive reinforcement member provided at or in an automotive part 8, here inside its hollow cavity. The axial length of the reinforcement member 13 and the automotive part 8 are essentially the same. The adhesive and/or expandable material is provided adjacent to the inner surface of the automotive part 8. It can also be seen that in the present example the structure-improvement-part 4 in the end-section of the profile is connected to the ribs via an adhesive and/or expandable material. The structure-improvement-part 2-4 are distributed along the axial length 11 of the profile 1 as needed in order to improve the mechanical properties of the part of the vehicle that shall be reinforced, for example its energy absorbing-, load-path-management-, a sealing-, a vibration-dampening-, anti-buckling, twist-resistance-improvement and/or a stiffening-properties.

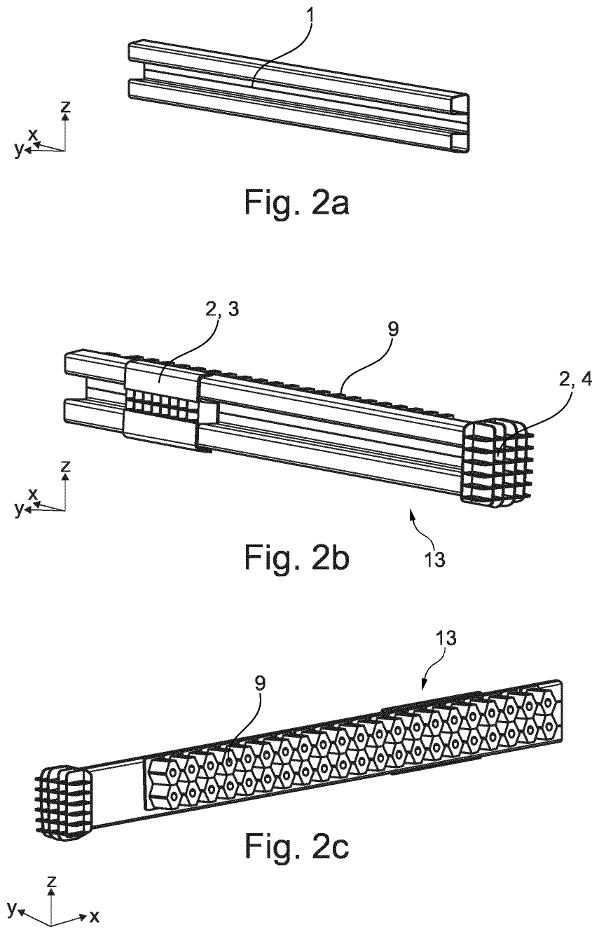

Regarding the following embodiments of the present invention, particularly the embodiments according to FIGS. 2-5 reference is made to disclosure made for the embodiment made according to FIG. 1. This disclosure applies to these embodiments likewise.

The profile 1 according to FIG. 2 comprises two hollow, preferably bent, longitudinal sections with a longitudinal groove in between. Opposite to the groove, the profile 1 is here flat. The groove is utilized to take up the carrier of a structure-improvement-part, which also comprises an adhesive-and/or expandable material, here provided at the periphery of the hollow sections. On the opposite, here the flat side, an additional structure-improvement-part 9, here a hoop-stress structure-improvement-part, is provided which extends along a larger length, here almost the entire length of the profile.

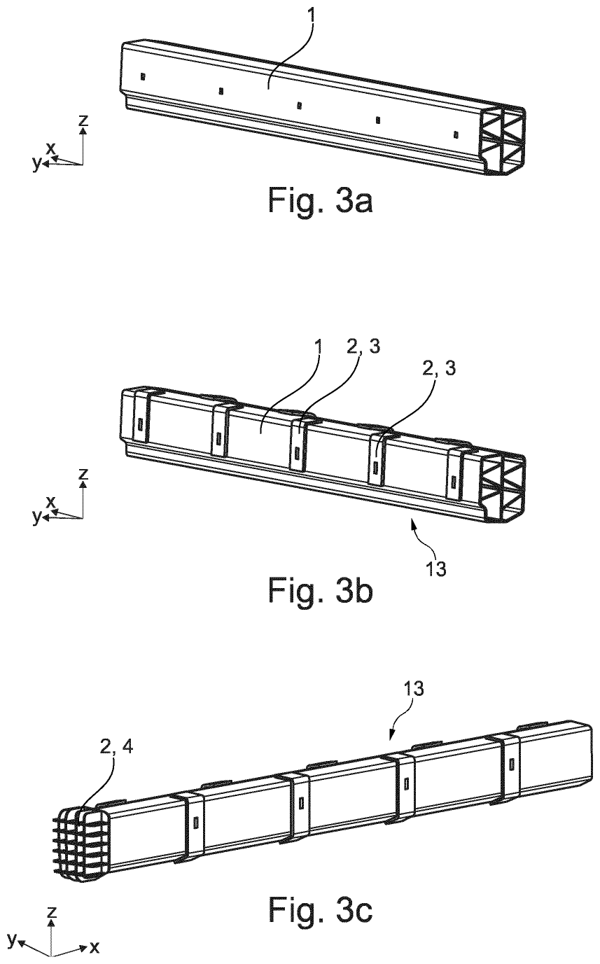

FIG. 3 shows yet another preferred embodiment of the reinforcement member 13. The profile 1 is here hollow and has ribs at the inner circumference. The profile is preferably ex- or pultruded and then cut to desired length. The structure-improvement-part 2, 3 preferably comprise in the present case only an adhesive and/or expandable material. The structure-improvement-part in the end-section of the profile is preferably the one described above.

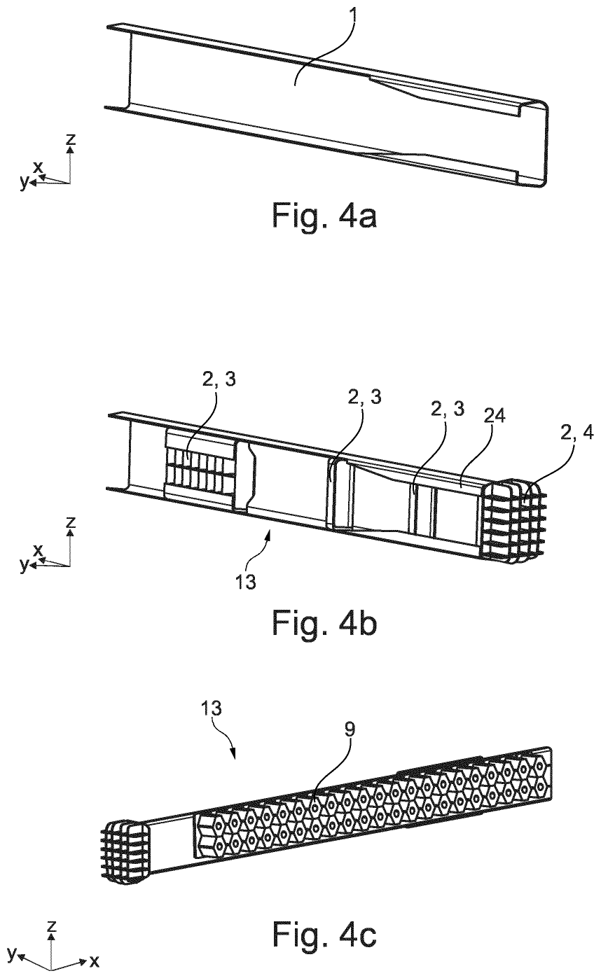

The profile according to the embodiment of FIG. 4 has essentially a cross-section which is essentially the same over the entire length: i.e. U-shaped. Only, here on the right-hand-side, the profile comprises an undercut 24, which provides more stability to the profile and/or can be utilized to fix a structure-improvement-part 2, 3. The structure-improvement-part are here at least partially different and adapted to the local load situation. At the surface opposite to the flanks of the U, an extended structure-improvement-part 9 hoop-stress structure-improvement-part, is provided.

FIG. 5 depicts an automotive part 8, here a battery case 14, which accommodates and protects the battery of an electric vehicle. The floor of the battery case can be the floor of the vehicle. The battery case comprises a rocker 15 and/or at least one, here two cross beam(s) 16, which are, preferably each, reinforced by the inventive reinforcement member 13.

FIGS. 6-13 each depict an embodiment of the inventive vehicle 10, here an electric-vehicle. In the embodiment according to m m, the vehicle 10 comprises two rockers 15 and a cross-member 16, which are all reinforced according to the present invention. Preferably, the are at least locally hollow and a reinforcement member is located inside and/or extends out of at least one of their ends.

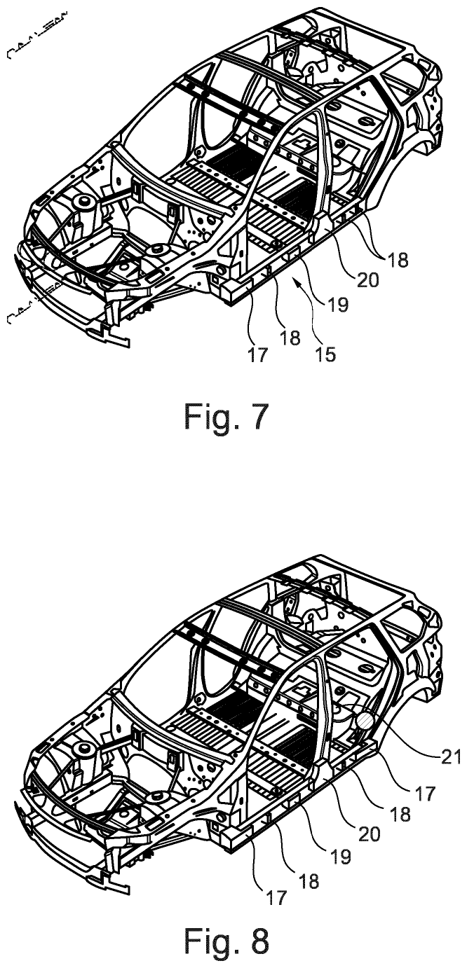

In the embodiment according to FIG. 7 exemplary details of a rocker 15 are provided. In the present case, the rocker a profile at which, starting from the left, an energy absorber and/or load path diverter 17, an anti-bucking-structure-improvement-part and/or anti-vibration structure-improvement-part 18, a hoop-stress-structure-improvement-part 19, a connector 20 and two more anti-bucking-structure-improvement-part and/or anti-vibration structure- improvement-parts 18 are provided, to account for the local load situation. The such reinforced rocker is specifically useful to protect the battery of an electric vehicle, which is located adjacent to the rocker. The skilled person understands that the rocker may comprise less or more structure-improvement-parts 17-20 and/or they are arranged and/or sized differently.

The embodiment according to FIG. 8 depicts a rocker designed for a fuel-cell driven electric vehicle with a gas-tank 21, here under the rear-seat of the vehicle. The arrangement is similar to the embodiment according to FIG. 7, except that the last two anti-bucking-structure-improvement-part and/or anti-vibration structure-improvement-parts 18 are substituted by a energy absorber and/or load path diverter 17, to divert a crash-load away from the gas-tank 21.

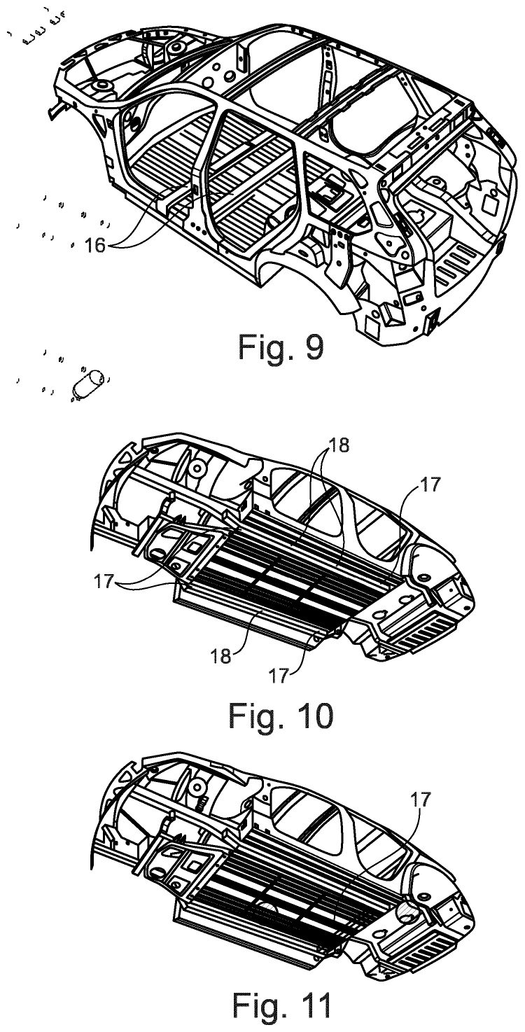

FIG. 9 depicts an electric vehicle with two beams 16 across the battery case. The cross beams may comprise a reinforcement member specifically adopted to take up a load from the seat(s) and/or from other vehicle components.

FIGS. 10 and 11 show embodiment with one or more axial rails preferably additionally to a rocker. The rails may be reinforced with an energy absorber and/or load path diverter 17 at one or both ends and/or anti-bucking-structure-improvement-part and/or anti-vibration structure-improvement-parts 18. In the embodiment according to FIG. 11 additionally or alternatively a cross member below the gas-tank is provided, which may be connected to the rocker and/or the axial rails by one mor more connector(s) 17 and/or energy absorber(s) and/or load path diverter(s) 17

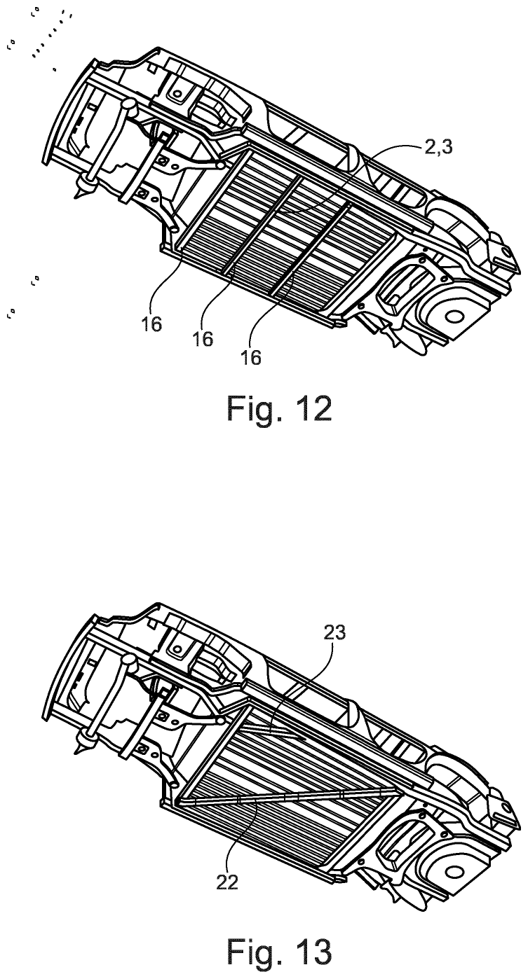

FIGS. 12 and 13 show embodiments of the improvement of the structure of a battery case. In the example according to FIG. 12 one or more cross-beams 16 are located below the battery cell. The cross beams are designed according to the present invention as indicated by the structure-improvement-part. In the embodiment according to FIG. 13, the improvement of the structure of the battery case is provided by at least one beam(s) 22, 23 which is/are provided at an angle different from 90° relative to the rocker. In the present case a diagonal-and a corner reinforcement beam are depicted, one or both designed according to the present invention.

FIG. 14 shows several different embodiments of the cross-section of the reinforcement member 13. All embodiment comprise a profile and a structure reinforcement part 2, each with a carrier and an adhesive and/or an expandable material. As can be seen form embodiments:
a), b), c), i)-k), the structure-improvement-part 2 can only be provided on the outer periphery of the profile 1,
d)-f), h, j) the structure-improvement-part 2 can only be provided on the inner periphery of the profile 1,
g), j), k) the structure-improvement-part 2 can be provided on the outer and inner periphery of the profile 1,
a-c), f), g)-k) the structure-improvement-part 2 can extend out of the periphery of the profile,
d), e) the structure-improvement-part 2 does not extend out of the outer periphery of the profile 1,
a)-k) an adhesive 7 is provided between the carrier and the profile,
i) the structure-improvement-part 2 can connect two profiles 1
h) the profile may comprise an opening through which the structure- improvement-part 2 extends,
c) the structure-improvement-part 2 can extend around the entire outer periphery of the profile 1,
a), b) the structure-improvement-part 2 can extend only around a segment of the outer periphery of the profile 1,
k) two, preferably different, structure-improvement-parts 2 may be located on opposite sides of the profile 1
a)-d) the profile may be a hollow structure, preferably with ribs (a)-c)),
e)-h the profile may be U or V-shaped and/or
j), K) the profile may be W-shaped

The inventive reinforcement member may comprise one or more of the above mentioned features. The disclosure concerning FIG. 14 also apply to all other examples provided above or to the entire disclosure provide in the general part of description of the invention or in the claims.

FIG. 15 shows a structure-improvement-part 2, 3 which can be utilized to reinforce a profile 1 from the inside; i.e. the structure-improvement-part 2, 3 is inserted into the profile 1. Preferably, the longitudinal axis of the structure-improvement-part 2, 3 is parallel to the longitudinal axis of the profile 1. In the present case, the structure-improvement-part 2, 3 comprises one, preferably a multitude of rib(s), which preferably extend perpendicular to the longitudinal axis of the structure-improvement-part 2, 3. The ribs are preferably provided equidistantly. The structure-improvement-part 2, 3 may comprise an adhesive to connect it to the profile 1. In the present case, the cross-section of the structure-improvement-part 2, 3 is, at least essentially, triangular.

FIG. 16 shows a profile 1 which is reinforced by a structure-improvement-part 2, 3 according to FIG. 15, provided inside the profile 1. In the present case, the inner cross-section of the profile is divided by longitudinal ribs 26. One or more of these ribs may define a compartment, into which the structure-improvement-part 2, 3 is inserted and preferably adhered. In the present case, the cross-section of a compartment is triangular and/or rectangular, and/or a parallelogram and/or a pentagon and/or a hexagon and/or a polygon. The person skilled in the art understand that more than one, preferably two, three, four, five or more of the compartments can be provided with a structure-improvement-part 2, 3. The cross section of the structure-improvement-part 2, 3 and the cross section of the compartment, into which the structure-improvement-part 2, 3 is inserted, have preferably the same shape and the cross section of the structure-improvement-part 2, 3 is preferably smaller than the cross section of the compartment. The axial length of the structure-improvement-part 2, 3 may be shorter than the axial length of the profile 1. Into one or more, for example two, three, four five, six, seven or all compartments structure improvement-parts can be inserted.

1. A reinforcement member for a vehicle, particularly an electric vehicle, wherein the reinforcement member comprises at least one profile, each with an axial extension and a perimeter and with at least one, preferably a multitude, of structure-improvement-part(s) provided at, at least, a section of the perimeter of the profile(s) and/or inside the profile(s).

2. The reinforcement member according to claim 1, wherein the profile is a continuous profile whose cross-section, at least essentially, does not change along its axial extension, preferably an extruded-and/or pultruded-and/or mechanically formed profile.

3. The reinforcement member according to claim 1, wherein the profile is made from a metal, preferably aluminum or a sheet metal or an organic material, preferably a composite body.

4. The reinforcement member according to claim 1, wherein it comprises a multitude of structure-improvement-part(s), which are distributed along the axial length of the profile.

5. The reinforcement member according to claim 1, wherein the profile comprises two end-sections and that at least one end section is provided with a structure-improvement-part.

6. The reinforcement member according to claim 1, wherein the reinforcement member comprises a connector.

7. The reinforcement member according to claim 1, wherein the structure-improvement-part comprises a carrier and/or an adhesive-and/or expandable-material.

8. Reinforcement member according to claim 1, the structure-improvement-part has an energy absorbing-, a load-path-management-, a sealing-, a vibration-dampening-, anti-buckling, twist-resistance-improvement and/or a stiffening-function.

9. An automotive part comprising a reinforcement member according to claim 1.

10. The automotive part according to claim 9, wherein the automotive part includes a hollow structure or having a cavity, wherein the reinforcement member is provided in the hollow structure or the cavity.

11. The automotive part according to claim 9, comprising an axial length, wherein the axial length of the reinforcement member is at least essentially equal to the axial length of the automotive part.

12. The automotive part according to claim 10, wherein the structure-improvement-parts are distributed along its axial length.

13. The automotive part according to claim 12, wherein, the structure-improvement-parts are identical or differ in their shape, size and/or chemical composition.

14. An automotive part comprising a reinforcement member and a structure-improvement-part at its circumference.

15. The automotive part according to claim 14, wherein the structure-improvement-part is a connector that connects two automotive parts.

16. The automotive part according to claim 9, wherein the automotive part is a rocker.

17. The automotive part according to claim 9, wherein the automotive part is a part of a battery case or a battery enclosure.

18. The automotive part according to claim 9, wherein the automotive part is a cross-member.

19. An electric vehicle comprising an automotive part according to claim 9.
